(19) United States
(12) Patent Application Publication
(10) Pub. No.: US 2025/0262834 A1
(43) Pub. Date: Aug. 21, 2025

(54) METHOD AND DEVICE FOR PRODUCING A TRAY LINED WITH A FOIL

(71) Applicant: ECKO-PACK GMBH, Neumünster (DE)

(72) Inventor: Marcel LEWERENZ, Neumünster (DE)

(21) Appl. No.: 18/036,331

(22) PCT Filed: Nov. 11, 2021
(86) PCT No.: PCT/EP2021/081323

§ 371 Date: Oct. 1, 2023

(30) Foreign Application Priority Data
Nov. 11, 2020 (DE) 10 2020 129 730.0

(51) Int. Cl. B31B 50/00; B31B 105/00; B31B 120/40

(52) U.S. Cl. CPC B31B 50/00; B31B 2105/001; B31B 2105/0024; B31B 2120/404

(57) ABSTRACT

A method for producing a shell lined with a film, in particular a shell for receiving food is provided, the method having the steps of: erecting an unfolded sheet of a paper fiber-based material in order to form a shell comprising a base, a lateral wall which has an upper edge and which consists of at least two lateral wall parts, wherein laterally adjacent lateral wall parts are designed to overlap with one another, and a collar which runs circumferentially on the upper edge and extends outwards therefrom and which defines an access opening, positioning the film above the access opening, heating the film, fixing the film on the collar, and supplying compressed air to the film side facing away from the shell in order to blow the film into the access opening in order to laminate the base and the lateral wall with the film.

### CROSS REFERENCE TO RELATED APPLICATIONS

This application is a 35 U.S.C. § 371 national stage application of PCT International Application No. PCT/EP2021/081323 filed on Nov. 11, 2021, which in turn claims priority to German Patent Application No. 102020129730.0, filed on Nov. 11, 2020, the disclosures and content of which are incorporated by reference herein in their entireties.

### TECHNICAL FIELD

The present disclosure relates to a method and a device for producing a tray lined with a foil, in particular a tray for receiving food.

Methods and devices of this type are known from the prior art. For instance, a method for arranging a foil on a tray has become known, for example, from EP 2 687 360 B1, in the case of which an edge of the foil is adhered only partially to a collar of the tray, so that the outer edge of the foil is exposed from the collar. A method for providing a packaging for packaging with modified atmosphere has become known from EP 2 441 697 B1, in the case of which an unfolded sheet is folded in order to form a box, wherein adjacent wall parts of the box abut against one another.

### SUMMARY

It is the object of the present disclosure to improve methods and devices of the above-mentioned type.

This object is solved by means of the subject matters of the independent claims.

The present disclosure comprises in particular the knowledge that the methods and devices known from the prior art for producing a tray lined with a foil, in particular also the methods of the above-cited prior art, line a tray with a foil, in that the foil is both pushed into the tray from the top by means of a die and suction openings are simultaneously provided in a lower tool below the tray, in order to extract air below the tray and to thus generate a vacuum, in order to suction the foil against the tray. The inventor has recognized that these known methods and devices are complex and are associated with high costs. This is so because in terms of the method, a complex coordination of the die for pushing in the foil with the extraction means for extracting air and for generating vacuum below the tray for suctioning the foil is necessary. On the other hand, the production of extraction openings in the lower tool along with a corresponding vacuum generating means including corresponding sealing measures is necessary in the case of the corresponding device. The suctioning of secondary air can in particular occur in the case of the above-mentioned methods known from the prior art when extracting air below the tray. It may thus happen that the vacuum below the tray is not sufficient in order to provide sufficient vacuum through the tray material, in order to reliably suction the foil against the tray.

The present disclosure has furthermore recognized that the trays known from the above-cited prior art have wall parts, which abut against one another only in a flush manner. In particular in the case of paper fiber-based materials, such as in the case of cardboard, it can thus happen that foil is pushed into or sucked into the wall parts of the tray, respectively, which are only flush with one another, so that this can result in an unflattering appearance and even to holes in the foil lining.

The subject matters of the independent claims of the present disclosure now provide the advantage that due to the supply of compressed air to a side of the foil facing away from the tray in order to blow the foil into the access opening in order to laminate the base and the lateral wall with the foil, a coordination of a die for pushing the sensitive foil into and against the tray as well as the complex generation of vacuum below the tray or the provision of extraction openings in the lower tool below the tray, respectively, can be forgone completely. Thanks to the present disclosure, this results in a strong simplification and thus in a cost savings in the case of the methods and devices according to the claimed subject matter This is so because, according to the disclosure, only compressed air has to be generated in order to attach the foil, but a die does not have to be moved in a defined manner against the sensitive foil. According to the present disclosure, no vacuum whatsoever needs to be generated. Thanks to the present disclosure, extraction lines also do not need to be supplied with a vacuum or have to be sealed against the suctioning of secondary air, respectively.

A preferred embodiment of the method is characterized in that for erecting purposes, the unfolded sheet is pushed into a, preferably air-impermeable, lower tool, more preferably with the help of a die, which lower tool preferably essentially represents a negative mold of the tray and/or of the die. A reliable erecting of the sheet is possible in this way.

A preferred embodiment of the method is characterized in that the foil is positioned above the access opening by means of a pulling device, preferably in such a way that the foil is pulled by means of the pulling device underneath a heating device, which is positioned on a side of the foil facing away from the access opening. The foil can preferably simultaneously be removed from a supply roll for the foil in this way.

A preferred embodiment of the method is characterized in that the foil is suctioned by means of a holding device, which is positioned on the side of the foil facing away from the collar, preferably at points of the foil corresponding to a geometry of the collar, and is preferably heated in a region of the foil located within a geometry of the collar, preferably by means of a heating device of the above-mentioned type, wherein heating device and holding device are preferably formed integrally. By means of the suctioning, the foil is held securely on the holding device even in the case of a change in shape caused by the heating.

A preferred embodiment of the method is characterized in that the foil is pressed onto the collar by means of a holding device holding the foil, preferably a holding device of the above-mentioned type, for fixing the foil on the collar. For the blow-in into the tray, the foil is securely fastened thereby.

A preferred embodiment of the method is characterized in that the base and the lateral wall is laminated with the foil without using vacuum between the tray and a lower tool representing a negative mold of the tray. No vacuum whatsoever thus has to be generated in order to laminate the foil.

A preferred embodiment of the method is characterized in that the base and the lateral wall is laminated with the foil without using adhesive. The avoidance of adhesive and the often difficult handling thereof saves significant costs.

A preferred embodiment of the device is characterized by a die for pushing the unfolded sheet into a, preferably air-impermeable, lower tool, which lower tool preferably essentially represents a negative mold of the tray. The die preferably has outer dimensions matching the negative mold.

A preferred embodiment of the device is characterized by a pulling device for positioning the foil above the access opening, preferably for pulling the foil underneath a heating device positioned on a side of the foil facing away from the access opening by means of the pulling device. The foil can preferably simultaneously be removed from a supply roll for the foil in this way.

A preferred embodiment of the device is characterized in that, the holding device comprises on a side facing away from the collar between tray and holding device positioned foil a suctioning means, which is formed to suction the foil, preferably at points of the foil corresponding to a geometry of the collar, and to heat the foil by means of the heating means, which is preferably integrated into the holding device, preferably in a region of the foil located within a geometry of the collar. By means of the suctioning, the foil is held securely on the holding device even in the case of a change in shape caused by the heating.

A preferred embodiment of the device is characterized in that the holding device is formed to press the foil onto the collar in order to fix the foil on the collar. For the blow-in into the tray, the foil is securely fastened thereby.

A preferred embodiment of the device is characterized in that the compressed air release means is formed to laminate the base and the lateral wall with the foil without using vacuum. No vacuum whatsoever thus needs to be used in order to laminate the foil. It is preferred thereby when a lower tool, which is arranged on the side of the tray facing away from the compressed air release means and which more preferably represents a negative mold of the tray, does not have any extraction openings and/or is air-impermeable.

### BRIEF DESCRIPTION OF THE DRAWINGS

The invention will be described in more detail below on the basis of the drawing. Identical or functionally identical parts are identified with the same reference numerals in the figures of the drawing. The figures of drawing each show schematic cross sectional drawings, in which in detail:

FIG. 1 shows a step A of an embodiment of the method according to the present disclosure or elements of an embodiment of the device according to the present disclosure, respectively;

FIG. 2 shows a step B of an embodiment of the method according to the present disclosure or elements of an embodiment of the device according to the present disclosure, respectively;

FIG. 3 shows a step C of an embodiment of the method according to the present disclosure or elements of an embodiment of the device according to the present disclosure, respectively;

FIG. 4 shows a step D of an embodiment of the method according to the present disclosure or elements of an embodiment of the device according to the present disclosure, respectively;

FIG. 5 shows a step E of an embodiment of the method according to the present disclosure or elements of an embodiment of the device according to the present disclosure, respectively;

FIG. 6 shows a step F of an embodiment of the method according to the present disclosure or elements of an embodiment of the device according to the present disclosure, respectively;

FIG. 7 shows a step G of an embodiment of the method according to the present disclosure or elements of an embodiment of the device according to the present disclosure, respectively;

FIG. 8 shows a step H of an embodiment of the method according to the present disclosure or elements of an embodiment of the device according to the present disclosure, respectively;

FIG. 9 shows a schematic illustration of an embodiment of a blank of an unfolded sheet according to the present disclosure or elements of an embodiment of the device according to the present disclosure, respectively; and

FIG. 10 shows a perspective view of a tray erected from the blank of FIG. 9 according to the present disclosure or elements of an embodiment of the device according to the present disclosure, respectively.

### DETAILED DESCRIPTION

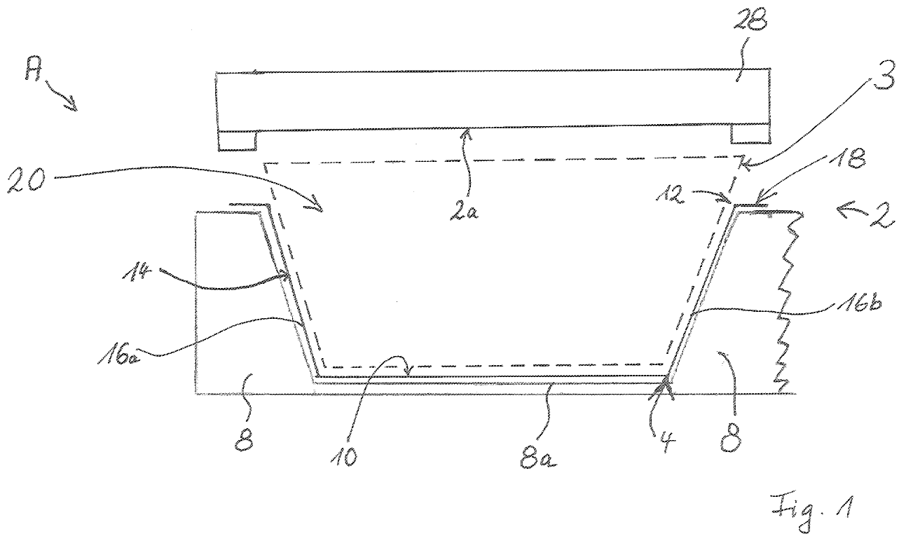

FIG. 1 shows a step A of a first embodiment of the method according to the i present disclosure or elements of an embodiment of the device according to the present disclosure, respectively. To understand the first embodiment of the method according to the invention, FIGS. 1 to 8 shall preferably be considered in their totality. To understand the first embodiment of the device according to the invention, it is likewise preferred to consider FIGS. 1 to 8 in their totality, in order to comprehend all elements of this first embodiment.

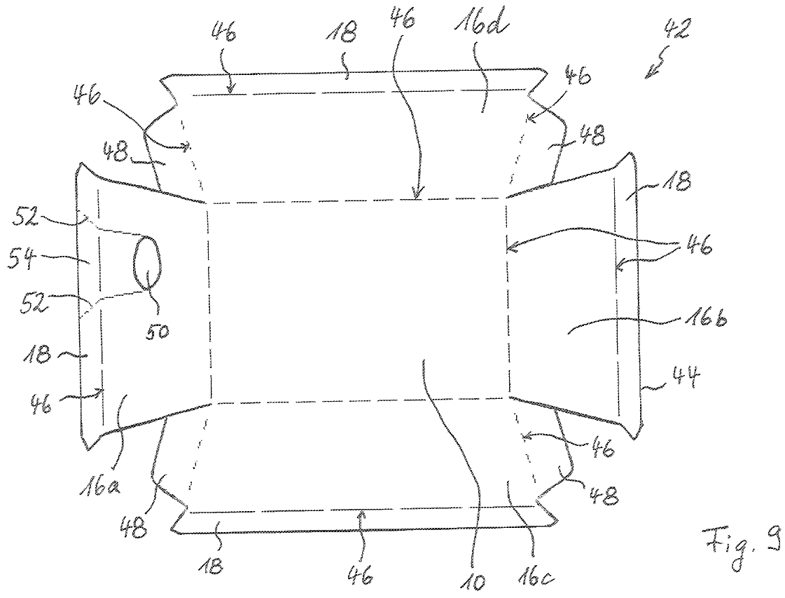

That being said, FIG. 1 shows a step A of the first embodiment of the method for producing a tray 4 lined with a foil 24, in particular for producing a tray 4 lined with a foil 24 for receiving food. For this purpose, an unfolded sheet, which is not illustrated in FIG. 1, of paper fiber-based material, for example a sheet 42 according to FIG. 9, is pushed into an air-impermeable lower tool 8 in the step A illustrated in FIG. 1 with the help of an erecting means 2, which has a die 3 illustrated in a dashed manner and is thus erected in order to form a tray 4. The lower tool 8 essentially consists of a negative mold 8a of the tray 4. The die 3 has outer dimensions matching the negative mold and, in order to erect the unfolded sheet 42, thus pushes the latter into the lower tool 8, whereby the tray 4 ends up in the erect shape illustrated in FIG. 1. In this respect, the die 3 and the lower tool 8 form elements of the erecting means 2 in the illustrated embodiment.

The tray 4 has a base 10 comprising a lateral wall 14 having an upper edge 12 consisting of at least two lateral wall parts 16a, 16b. Laterally adjacent lateral wall parts 16a, 16b are thereby formed to overlap with one another. This will be described in more detail further below with reference to FIG. 9. The tray 4 furthermore has a collar 18, which runs circumferentially on the upper edge 12 and extends outwards therefrom and which defines an access opening 20 of the tray 4. The overlapping, laterally adjacent lateral wall parts 16a and 16b are not adhered to one another. The lower tool 8 does not have any extraction channels or extraction openings, in order to suck the erected tray 4 into the trough-like negative mold 8a.

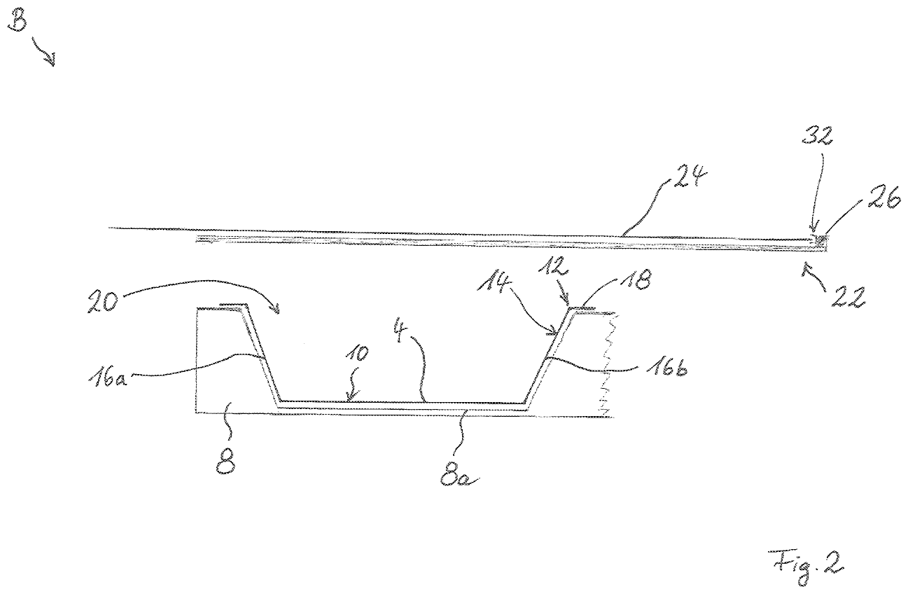

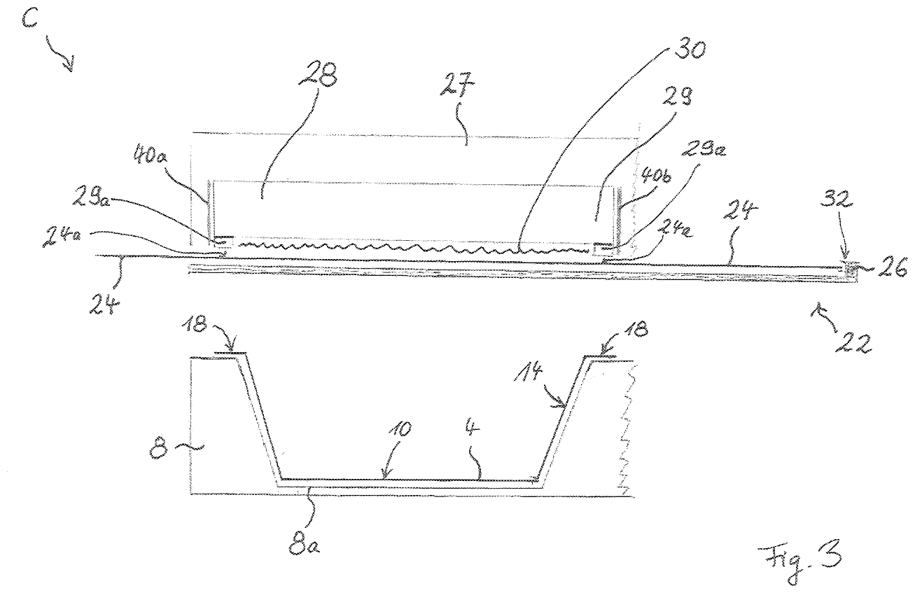

FIG. 2 shows a step B of the embodiment of the method according to the present disclosure or elements of an embodiment of the device according to the present disclosure, respectively. FIG. 2 in particular shows a positioning means 22 for positioning a foil 24 consisting essentially of plastic above the access opening 20. For this purpose, the positioning means 22 has a pulling device 26, in order to position the foil 24 above the access opening 20, preferably by means of the pulling device 26 the foil 24 is pulled underneath a heating device 30 illustrated in FIG. 3, which is positioned on a side of the foil 24 facing away from the access opening 20. For this purpose, the pulling device 26 has a clamp 32, by means of which a foil 24 is pulled over the access opening 20, preferably in the width of the tray 4. In the figures, the width of the tray 4 and thus the width of the foil 24 runs perpendicular to the drawing plane.

Following the positioning of the foil 24 above the access opening 20, the positioning means 22, which is also referred to as foil shuttle and which is formed as pulling device 26, moves out of the position illustrated in FIG. 2, in order to thus bring the foil into a state positioned directly above the access opening 20.

In order to, for example, hold the foil 24 in this position, a holding device 28 is provided according to FIG. 3 for a step C. On a side 34, which faces away from the collar 18, of the foil 24 positioned between tray 4 and holding device 28, the holding device 28, which is preferably provided in a housing 27, has a suctioning device 29, which is formed integrally with the holding device 28. The suctioning device 29 is formed to suction the foil 24 at points 24a with the help of suction nozzles 29a. The points 24a or the position thereof, respectively, on the foil 24 correspond to a geometry of the collar 18.

The state directly prior to suctioning the points 24a of the foil 24 by means of the suctioning means 29 is illustrated in FIG. 3, so that the points 24a are not yet in contact with the suctioning means 29. However, as soon as the foil 24 comes into contact with the suctioning means 29 or the suction nozzles 29a thereof, respectively, at the points 24a by means of the suctioning of the suctioning means 29, the positioning means 22 can be removed or moved out of the position illustrated in FIGS. 2 and 3, respectively.

A heating device 30 illustrated symbolically in FIG. 3 by means of a wavy line, which is integrated into the holding device 28, is provided between the suction nozzles 29a of the suctioning means 29, which are illustrated on the left and on the right in FIG. 3.

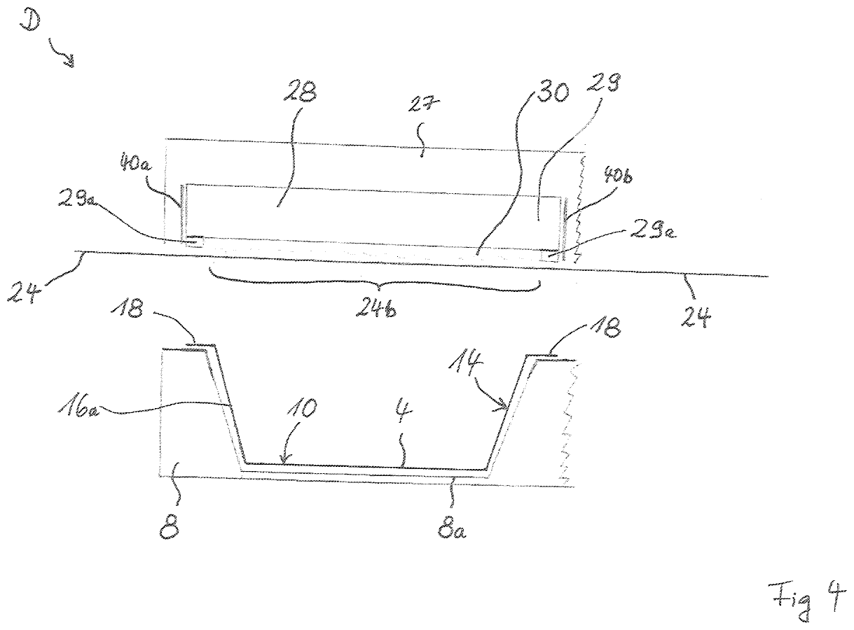

As illustrated with regard to a step D in FIG. 4, the heating device 30 is activated simultaneously with the suctioning of the foil 24 by means of the suctioning means 29 or immediately following the suctioning of the foil 24 by means of the suctioning means 29, in order to heat the foil 24 within a region 24b located within a geometry of the collar 18. For illustrative purposes, the foil 24 is illustrated in FIG. 4 at a distance from the suctioning means 29. In the method step D of FIG. 4, the foil 24 is in fact in contact with the suctioning means 29 and is thus held by means of the latter on the suctioning means 29 or on the holding device 28, respectively, and is simultaneously heated by the heating device 30 in the region 24b.

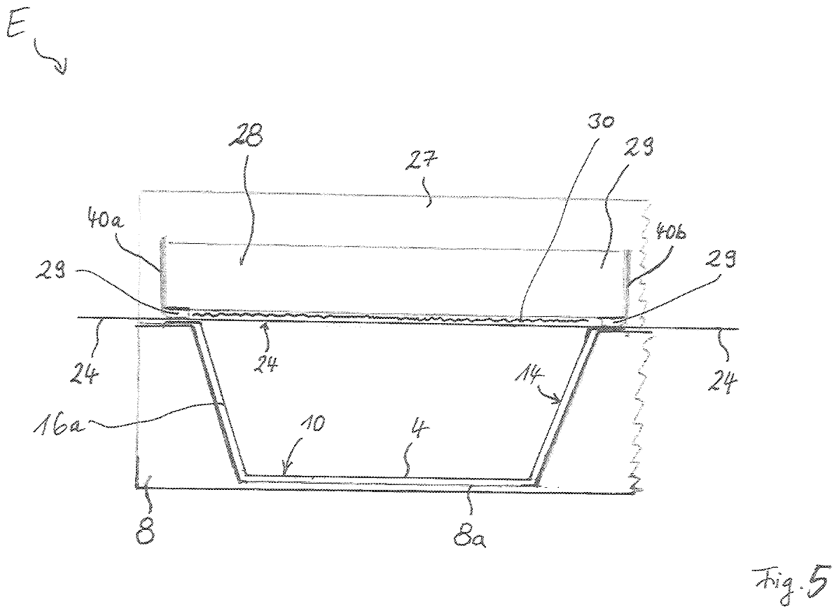

According to the step E illustrated in FIG. 5, the foil 24 is then pressed onto the collar 18 by means of the holding device 28 in order to fix the foil on the collar 18. For this purpose, the holding device 28 can either be moved against the lower tool 8, the lower tool 8 can be moved against the holding device 28, or both elements can be moved towards one another.

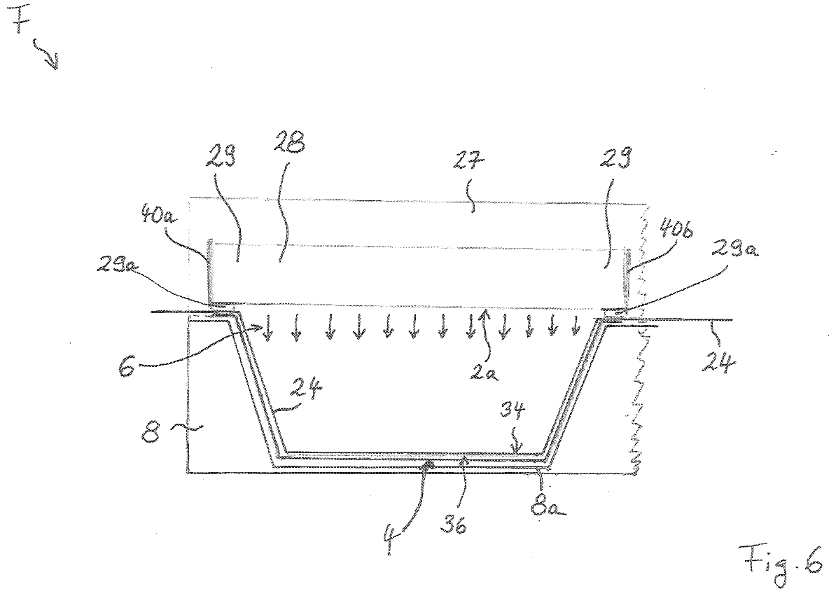

In the step F according to FIG. 6, compressed air 6 is subsequently blown in with the help of the compressed air release means 2a, in order to supply compressed air 6 to a side 34 of the foil 24 facing away from the tray 4 in order to blow the foil 24 into the access opening 20.

By supplying the compressed air 6 to the foil 24, the base 10 and the lateral wall 14 of the tray 4 is finally laminated with the foil 24. By means of this lamination of the base 10 and the lateral wall 14, which form the seal of the inner side of the tray 4, with the foil 24, the lateral wall parts 16a and 16b, which are formed to overlap with one another on their laterally adjacent sides, are also fixed. This is so because the lower side 36 of the foil 24 facing the tray 4 connects to the inner side of the tray 4 formed by base 10 and lateral wall 14, and also fixes the lateral wall parts 16a, 16b, which overlap with one another on their laterally adjacent edges, due to the heat introduced into the foil 24 by means of the heating device 30.

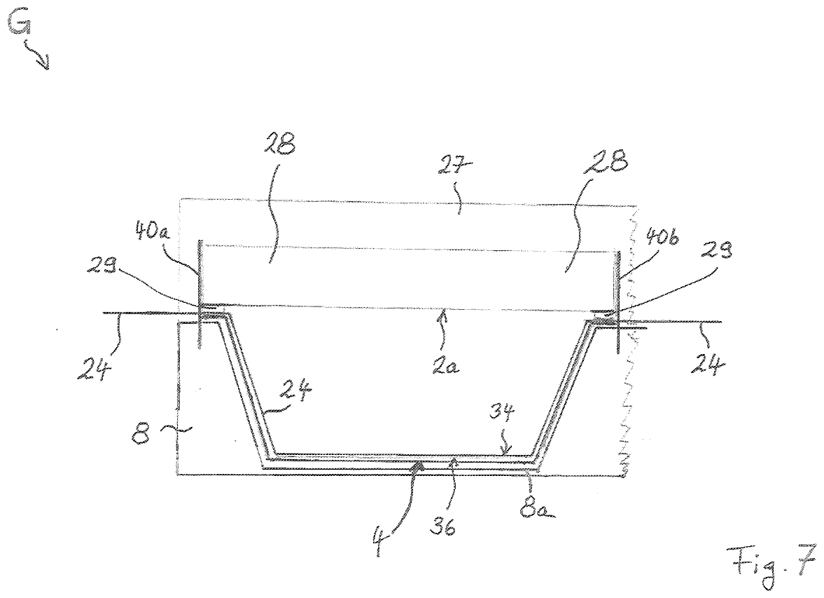

Due to the fact that the foil 24, which is now laminated into the tray 4, still protrudes beyond the collar 18 in the conveying direction and opposite to the conveying direction of the pulling device 26, the excess foil 24 is cut off with the help of blades 40a and 40b according to the step G illustrated in FIG. 7. For this purpose, the blades 40a and 40b are moved through the foil 24 perpendicular to the tray base 10 on the outside of the collar 18. The blades 40a and 40b are illustrated schematically in FIG. 7 in their lower end position of their cutting movement.

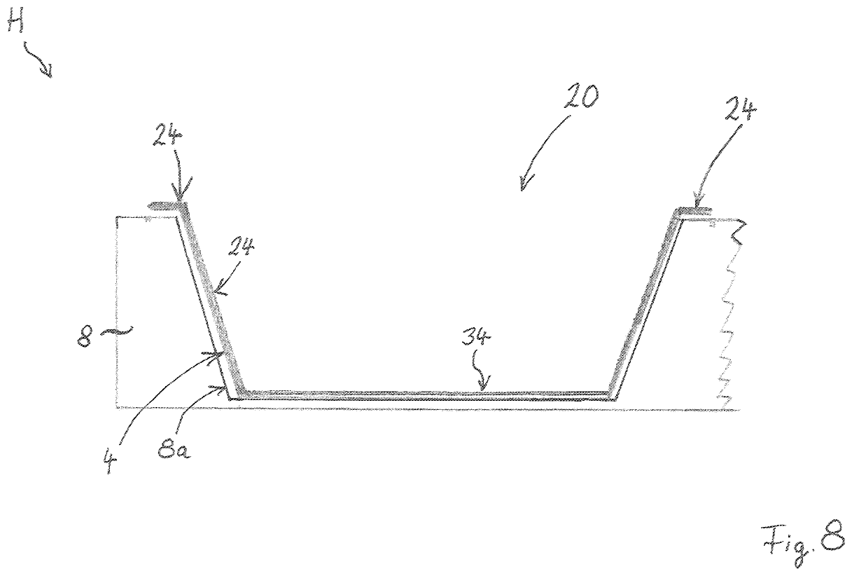

The step H according to FIG. 8 shows the tray 4, which is fully lined with foil 24. To clarify that the foil has sealingly connected to the base 10 or to the lateral wall 14, respectively, by means of lamination by means of heat introduced into said foil, tray 4 and foil 24 are illustrated as a thick line in the schematic cross sectional drawing of FIG. 8. By means of the lining or sealing, respectively, of the inner surface 10, 14 of the tray 4, the latter is now ready to receive food via the access opening 20.

FIG. 9 shows a schematic illustration of an embodiment of a blank of an unfolded sheet. According to the steps A to H of FIGS. 1 to 8, the illustrated unfolded sheet 24 can be erected according to the invention in order to form the tray 4 and can be laminated with the foil 24. The sheet 42 was produced in that it was cut out or punched out, respectively, from a non-illustrated, paper fiber-based raw material, such as cardboard, for example, along the continuous lines 44 from such a raw cardboard. Along the lines 46, which are illustrated in a dashed manner in FIG. 9, the cardboard has incisions, which make it easier to fold the sheet 42 along the dashed lines 46 in order to erect the sheet 42 to in order to form a tray 4. These incisions or creases 46 delimit the various parts of the sheet 42 from one another, which can then also be found in the tray 4, which is described with respect to FIGS. 1 to 8. The sheet 42 thus has a base 10, lateral parts 16a, 16b, 16c, and 16d. Likewise the collar 18, which still consists of four parts, in the unfolded sheet 42.

So that the laterally adjoining wall parts 16a, 16b, 16c, and 16d can overlap with one another, the lateral wall parts 16c and 16d have corresponding ears 48, which are likewise delimited from the lateral wall parts 16c and 16d by means of incisions or creases 46. When erecting the sheet 42, the ears 48 then overlap with the lateral wall parts 16a and 16b on the inner sides of the side wall parts 16a and 16b facing the access opening 20. The ear 48 illustrated on the bottom left in FIG. 9 then in particular overlaps with the edge of the lateral wall part 16a, which is illustrated on the bottom left in FIG. 9, the ear 48 illustrated on the bottom right in FIG. 9 overlaps with the lateral edge of the lateral wall part 16b illustrated on the bottom right in FIG. 9 during the erection, the ear 48 illustrated on the top left in FIG. 9 overlaps with the lateral edge of the lateral wall part 16a illustrated on the top left in FIG. 9 during the erection, and the ear illustrated on the top right in FIG. 9 overlaps with the lateral edge of the lateral wall part 16b illustrated on the top right in FIG. 9 during the erection of the tray 4. The sheet 42 can optionally have a hole 50 and a push-in portion 54, which is limited by means of perforations 52 in the lateral wall part 16a.

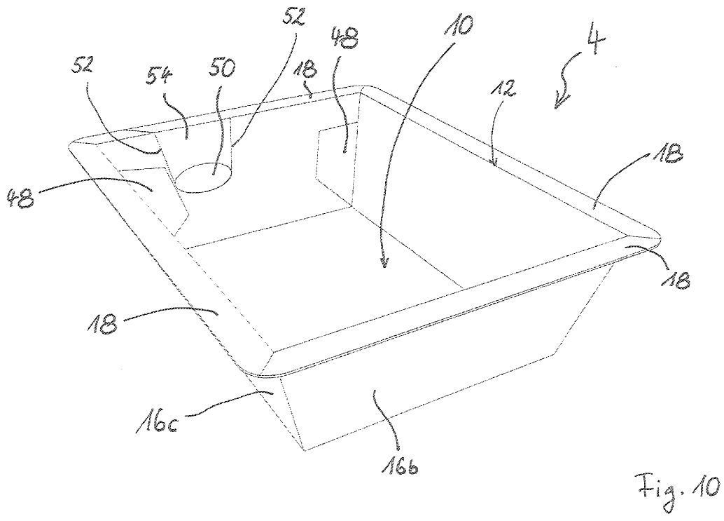

FIG. 10 shows a perspective view of a tray 4 erected from the blank of FIG. 9. It can be seen that the ears 48 overlap with the lateral wall parts 16a and 16b on the inner sides of the lateral wall parts 16a and 16b by means of the erecting of the sheet 42. The ears 48 are then fixed to the lateral wall parts 16a and 16b in this position by means of the lamination of the foil 24.

1. A method for producing a tray lined with a foil, in particular a tray for receiving food, comprising the steps of:
erecting an unfolded sheet of paper fiber-based material in order to form a tray comprising a base and comprising a lateral wall having an upper edge, the lateral wall having at least two lateral wall parts, wherein laterally adjacent lateral wall parts are formed to overlap with one another, and comprising a collar circumferentially extending along the upper edge and extending outwardly therefrom, which collar defines an access opening,
positioning the foil above the access opening,
heating the foil,
fixing the foil on the collar, and
supplying compressed air to a side of the foil facing away from the tray in order to blow the foil into the access opening in order to laminate the base and the lateral wall with the foil.

2. The method according to claim 1,
wherein the foil is positioned above the access opening by means of a pulling device, preferably in such a way that the foil is pulled by means of the pulling device underneath a heating device, which is positioned on a side of the foil facing away from the access opening.

3. The method according to claim 1,
wherein the foil is suctioned by means of a holding device, which is positioned on the side of the foil facing away from the collar, preferably at points of the foil corresponding to a geometry of the collar, and is preferably heated in a region of the foil located within a geometry of the collar, preferably by means of a heating device according to the preceding claim, wherein heating device and holding device are preferably formed integrally.

4. The method according to claim 1
wherein the foil is pressed onto the collar by means of a holding device holding the foil, preferably a holding device according to the preceding claim, in order to fix the foil on the collar.

5. The method according to claim 1,
wherein the base and the lateral wall is laminated with the foil without using vacuum between the tray and a lower tool representing a negative mold of the tray, wherein the base is laminated with the foil preferably without using adhesive and the lateral wall is laminated to the tray only by means of the heat introduced into the foil by means of heating.

6. A device for producing a tray lined with a foil, the tray for receiving food, the device having:
an erecting means for erecting an unfolded sheet of paper fiber-based material in order to form a tray comprising a base and comprising a lateral wall having an upper edge, the lateral wall having at least two lateral wall parts, wherein laterally adjacent lateral wall parts are formed to overlap with one another, and comprising a collar, circumferentially extending along the upper edge and extending outwardly therefrom, which collar defines an access opening,
a positioning means for positioning the foil above the access opening,
a heating device for heating the foils,
a holding device for fixing the foil on the collar, and
a compressed air release means for supplying compressed air to a side of the foil facing away from the tray in order to blow the foil into the access opening in order to laminate the base and the lateral wall with the foil.

7. The device according to claim 6, further comprising a die for pushing the unfolded sheet into a, preferably air-impermeable, lower tool for erecting purposes, which lower tool preferably essentially represents a negative mold of the tray and/or of the die.

8. The device according to claim 6,
comprising a pulling device for positioning the foil above the access opening, preferably for pulling the foil underneath a heating device positioned on a side of the foil facing away from the access opening by means of the pulling device.

9. The device according to claim 6,
wherein, on a side facing away from the collar, of a foil positioned between tray and holding device, the holding device has a suctioning means, which is formed to suction the foil, preferably at points of the foil corresponding to a geometry of the collar, and to heat the foil by means of the heating device, which is preferably integrated into the holding device, preferably in a region of the foil located within a geometry of the collar, wherein the holding device is preferably formed to press the foil onto the collar in order to fix the foil on the collar.

10. The device according to claim 6,
wherein the compressed air release means is formed to laminate the base and the lateral wall with the foil without using vacuum, wherein a lower tool, which is arranged on the side of the tray facing away from the compressed air release means and which more preferably represents a negative mold of the tray, does not have any extraction openings and/or is air-impermeable.
